(19) United States
(12) Patent Application Publication
(10) Pub. No.: US 2026/0115768 A1
(43) Pub. Date: Apr. 30, 2026

(54) Eyewear Cleaning Device

(71) Applicant: Clear Optics USA, Laguna Niguel, CA (US)

(72) Inventors: Theodore Arthur Patience, Laguna Niguel, CA (US); Daniel Ray Ash, JR., Laguna Niguel, CA (US)

(21) Appl. No.: 18/930,749

(22) Filed: Oct. 29, 2024

(51) Int. Cl. B08B 1/40; A44B 99/00; B08B 1/14; B08B 11/00

(52) U.S. Cl. CPC B08B 1/40; A44B 99/00; B08B 1/143; B08B 11/00

(57) ABSTRACT

An eyewear cleaning device has a storage housing with a housing cover and a side flange, the side flange having an aperture. The device also includes a cleaning cloth with a stop plug at a proximal end and a retraction cord at a distal end. The retraction cord is coiled upon a spool of the storage housing, and a retraction mechanism biases the spool to retract the retraction cord so that the cleaning cloth is retracted into the storage housing until the stop plug abuts the aperture in the side flange of the storage housing. An enclosure tank holds a cleaning fluid, and a pump mechanism pumps the cleaning fluid from the enclosure tank into the storage housing to moisten the cleaning cloth.

### BACKGROUND OF THE INVENTION

### Field of the Invention

This invention relates generally to eyewear cleaning devices, and more particularly to an eyewear cleaning device that is modular and refillable.

### Description of Related Art

Various forms of eyewear are important in both sports and also in general daily life. They are important for visual aid (prescription), and also for providing eye protection. Eye products are worn for many reasons and are often essential for outdoor sports and work activities. Eyewear protection including vision correction products help protect the user from the sun, and help reduce the glare while driving, riding, skiing, working or playing sports.

A major problem that is encountered by persons who wear protective eye wear is the fact that they become dirty, foggy, muddy, dusty, and smudged, and require cleaning. Cleaning goggles, sunglasses and other action sports eyewear is problematic because of the lack of mounting methods and lack of areas to access to products that have a cloth and liquid in one place, easy to easy access and use quickly.

Keeping goggles, sunglasses, and similar eyewear clean and dirt-free during action sports eyewear is important not just for convenience, but also for the safety of the participant. The problem of cleaning eyewear such as sunglasses becomes more acute in the field of action/outdoor sports. When engaged in action/outdoor sports where one desires to wear goggles or sunglasses, there is a need to quickly and readily clean the glasses so as not to interrupt the sports activity. For example, a skier's or snowboarder's goggles can become fogged or dirty from the snow and dirt. If the goggles are not readily cleaned, it reduces the wearer's ability to see the ski slopes and could lead to a dangerous situation. The same is true for other sports such as motorsports & cycling. Off-road adventures are normally sources of dust and dirt.

With all of the problems associated with the need to keep eyewear clean, there is a great need for an improved eyewear cleaning device with a liquid feature and cloth, which is readily accessible, not easily lost, can be mounted on a vehicle or worn, and overcomes the above problems associated with the cleaning of such eyewear.

The prior art teaches eyewear cleaning devices. However, the prior art does not teach a fully self-contained, mountable and wearable eyewear cleaning device, which includes a reservoir for providing a cleaning fluid. The present invention fulfills these needs and provides further advantages as described in the following summary.

### SUMMARY OF THE INVENTION

The present invention teaches certain benefits in construction and use which give rise to the objectives described below.

The present invention provides an eyewear cleaning device comprising a storage housing having a housing cover and a side flange, the side flange having an aperture. The device also includes a cleaning cloth having a stop plug at a proximal end and a retraction cord at a distal end. The retraction cord is coiled upon a spool of the storage housing, and a retraction mechanism biases the spool to retract the retraction cord so that the cleaning cloth is retracted into the storage housing until the stop plug abuts the aperture in the side flange of the storage housing. An enclosure tank holds a cleaning fluid, and a pump mechanism pumps the cleaning fluid from the enclosure tank into the storage housing to moisten the cleaning cloth.

A primary objective of the present invention is to provide an eyewear cleaning device having advantages not taught by the prior art.

Another objective is to provide an eyewear cleaning device having a retractable cleaning cloth for cleaning eyewear.

A further objective is to provide an eyewear cleaning device having an enclosure tank that pumps cleaning fluid to moisten a cleaning cloth for cleaning eyewear.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of an eyewear cleaning device according to one embodiment of the present invention, illustrating the cleaning cloth in a retracted position inside a storage housing;

FIG. 2 is a perspective view thereof, showing a cleaning cloth once it has been pulled out of the storage housing to an extended position for use;

FIG. 3 is an exploded perspective view of the eyewear cleaning device; and

FIG. 4 is a bottom perspective view thereof;

### DETAILED DESCRIPTION OF THE INVENTION

The above-described drawing figures illustrate the invention, an eyewear cleaning device that is mountable and portable for cleaning lenses.

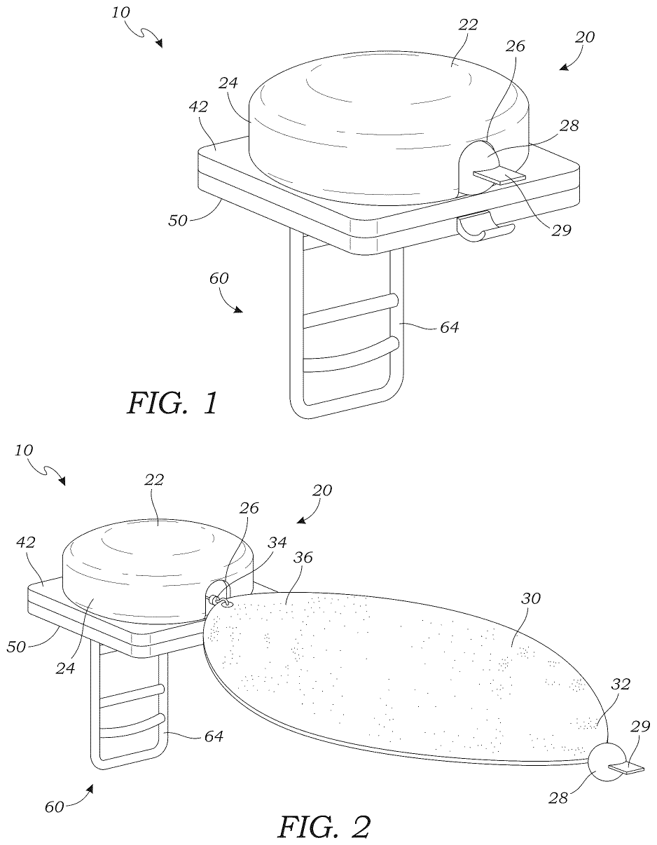

FIG. 1 is a perspective view of an eyewear cleaning device 10 according to one embodiment of the present invention, illustrating a cleaning cloth 30 in a retracted position inside a storage housing 20. FIG. 2 is a perspective view thereof, showing the cleaning cloth 30 once it has been pulled out of the storage housing 20 to an extended position for use.

For the purposes of this application, the term “eyewear,” is defined to include any form of eyewear, including, but not limited to eyeglasses, sunglasses, sport goggles, work goggles, eye-shields, etc. Similarly, the term “lens” refers to any portion of the eyewear that allows visibility, which may be a wide range of sizes, shapes, and materials (glass, plastic, etc.).

As shown in FIGS. 1-2, in this embodiment, the storage housing 20 includes a housing cover 22 and a side flange 24, the side flange 24 having an aperture 26 for accessing the cleaning cloth 30. The housing may serve to protect the cleaning cloth 30 from elements like dirt, dust, and water. In this embodiment, the side flange 24 is mounted on top of the enclosure tank 50, so that a top portion 42 of the enclosure tank 50 forms the bottom of the storage housing 20. As illustrated, the cleaning cloth 30 includes a stop plug 28 at a proximal end 32 and a retraction cord 34 at a distal end 36. The aperture 26 of the side flange 24 is large enough to allow the retraction cord 34 and the cleaning cloth 30 to pass through, but is small enough that it blocks the stop plug 28 from passing through. In some embodiments, the stop plug 28 includes a pull tab 29 so that the user may grip the pull tab 29 to pull the cleaning cloth 30 out of the storage housing 20 (FIG. 2).

As shown in FIG. 2, the cleaning cloth 30 may be in a generally ovular/tapered shape, but in other embodiments, it may be any desired shape (e.g., rectangular, irregular/ornamental, triangular, etc.). In various embodiments, the cleaning cloth 30 may be a microfiber material typical for eyewear accessories, but in some cases the cleaning cloth 30 may be formed of a different material(s), as deemed suitable by those skilled in the art. In this embodiment, the cleaning cloth 30 is approximately 4″ by 6″, but any desired dimensions may be constructed, as long as it can fully retract into the storage housing 20. In some applications, the storage housing 20 may be a wide range of sizes, for housing different cleaning cloths. In one example, the eyewear cleaning device 10 may be sized to wipe off larger objects such as vehicle parts, or large lenses such as those found on telescopes, magnifiers, etc.

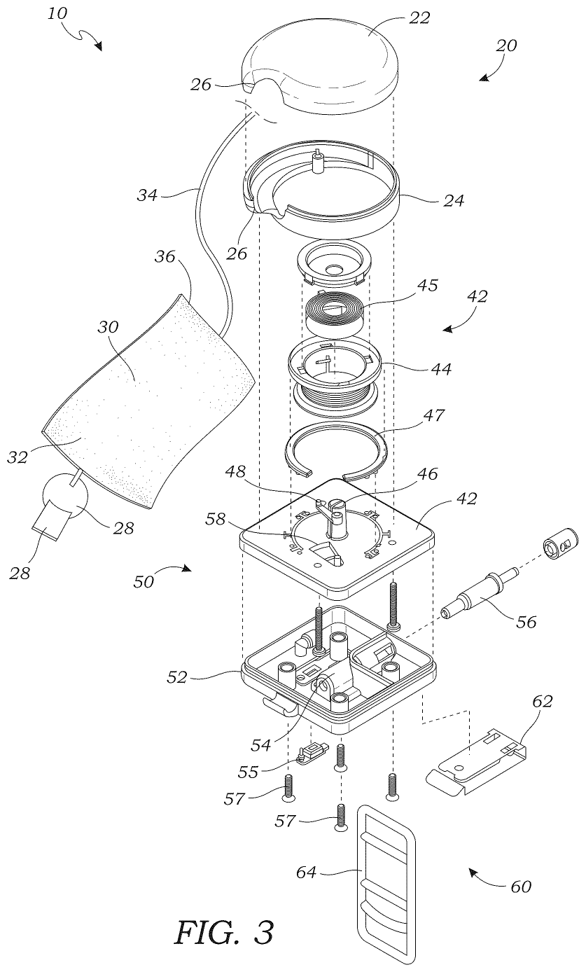

FIG. 3 is an exploded perspective view of the eyewear cleaning device 10. As shown in FIG. 3, a retraction mechanism 42 is located within the storage housing, for retracting the retraction cord 34 and the cleaning cloth 30 until the stop plug 28 abuts the aperture 26 in the side flange 24 of the storage housing. The retraction cord 34 is coiled upon a spool 44 of the storage housing. In some embodiments, the retraction cord 34 is constructed of a Kevlar material, but in other embodiments, any type of fibers, wires, cables, etc. may be used. In some embodiments, the retraction cord 34 may be detachable from the cleaning cloth 30, so that the cleaning cloth 30 may be replaced without having to replace the entire device 10.

In this embodiment, the retraction mechanism 42 comprises a spindle 46 that extends upwardly from the top portion 42 of the enclosure tank 50, wherein the spool 44 rotates on the spindle 46. The retraction mechanism 42 may further include a spring 45 within the spool 44 and surrounding the spindle 46. A gasket 47 may be formed around the spindle 46 for retaining the spool 44, and a pivot arm 48 may be formed in the top portion 42, within the gasket 47. In this manner, the retraction mechanism 42 allows the spool 44 to unravel outwardly to allow the cleaning cloth 30 to exit the storage housing, wherein the pivot arm 48 stops the spool 44 from retracting while the cleaning cloth 30 is being pulled outwardly. In some embodiments, the pivot arm 48 releases once the retraction cord 34 is fully extended, as is well-known for this type of mechanism. Alternatively, the locked spool 44 may be released via a different means, such as a switch, button, or similar means. Furthermore, in some embodiments, the spool 44 does not lock in place, and instead maintains a constant resistance. While one example of a retraction mechanism is shown and described, other types of ratchets or related mechanisms may be implemented, which should be considered within the scope of the present invention.

As shown in FIGS. 3, the eyewear cleaning device 10 further comprises an enclosure tank 50 that holds a cleaning fluid for cleaning the cleaning cloth. As shown in FIG. 3, in this embodiment the enclosure tank 50 includes the top portion 42, and a bottom portion 52 that contains a refillable fluid reservoir 54 and a pump mechanism 56 for pumping the cleaning fluid from the fluid reservoir 54 into the storage housing to moisten the cleaning cloth 30. As illustrated, the bottom portion 52 and the top portion 42 may be fastened together via a fastener 57. In this embodiment, the fastener 57 is in the form of a plurality of screws, but any form of fastener may be included, e.g., a strong adhesive, pins, hooks, etc. In this embodiment, the pump mechanism 56 is in the form of a button with exterior access that pumps the cleaning fluid from the fluid reservoir 54 and through an opening 58 in the top portion 42 to moisten the cleaning cloth 30 within the storage housing. However, the pump mechanism 56 may be any form of mechanism adapted to pump the cleaning fluid into the storage housing.

In use, the cleaning cloth 30 may be moistened by the cleaning fluid, such as by the user pressing a pump button or similar mechanism, and then the cleaning cloth 30 may be pulled out of the storage housing 20, from the retracted position of FIG. 1, to the extended position shown in FIG. 2. The cleaning cloth 30 may then be used for wiping a lens of eyewear (not shown), and then allowed to retract back into the storage housing 20. Other items may also be wiped with the cleaning cloth 30, e.g., touch screens, mirrors, jewelry, mechanical parts, etc.

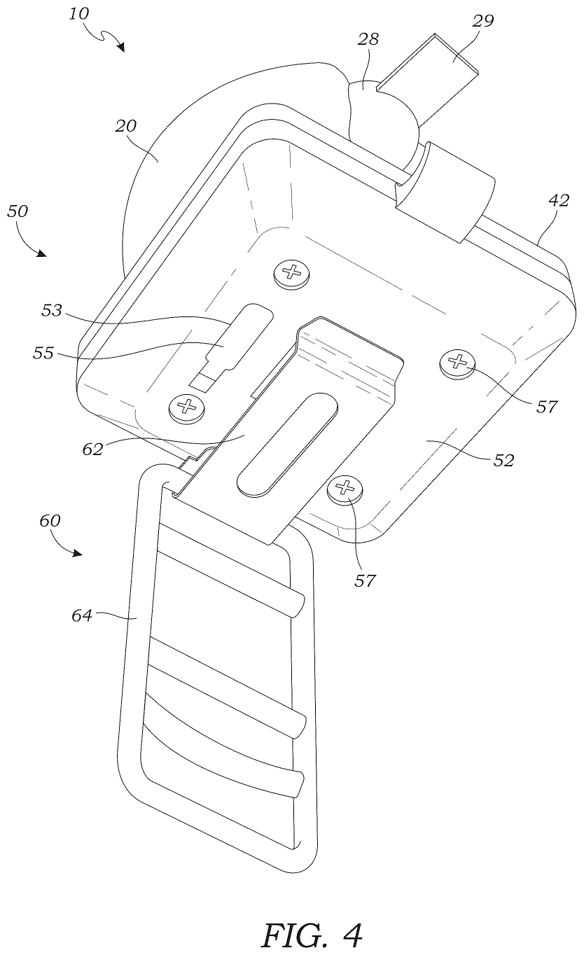

FIG. 4 is a bottom perspective view of the eyewear cleaning device 10. As shown in FIG. 4, a mounting mechanism 60 may be mounted to the bottom portion 52 of the enclosure tank 50, or any other suitable portion of the eyewear cleaning device 10, for facilitating the fastening of the device 10 to the user. In this embodiment, the mounting mechanism 60 comprises a horizontal belt clip 62 and a downwardly extending mounting frame 64. The mounting frame 64 may be constructed of rubber, though any suitable materials may be included. The mounting frame 64 may be pivotable, and may be attached to various external objects such as straps, clips, etc. While one example of the mounting mechanism 60 is illustrated and described herein, a wide range of potential mounting mechanisms may be constructed, e.g., a hook and loop fastener, tying strap, clip, etc.

The bottom portion 52 of the enclosure tank 50 may also include a fill port 53 having a fill plug 55 for replacing the cleaning fluid. The fill plug 55 may be in the form of a resilient plug, or it may alternatively be in the form of a friction-fit or threaded cap, slide-closure, or any other similar structure. The cleaning fluid may be any suitable type of fluid, having ingredients for anti-fog, anti-dust, and/or glass cleaning.

In use, the user may wear the eyewear cleaning device 10 on an article of wear, or mount it to an exterior object, such as a belt, shirt pocket, cuff/collar, backpack, bicycle/vehicle part, workspace furniture/machinery, etc. The eyewear cleaning device 10 may be used in any feasibly useful context, but may be especially desirable to cyclists, offroad enthusiasts, and those working with protective goggles, where debris may be in the range of eyewear (production, construction, machinery, etc.). In this manner, the user would not need to cease activity in order to locate, unpack, use, and repack a prior art cleaning device, which are typically provided as kits with separate components (spray bottle, cleaning cloth, storage case). However, the present invention is an easily accessible, self-contained cleaning device that automatically retracts. The design is compact and discreet so it may blend seamlessly with a uniform, exercise gear, etc.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. An eyewear cleaning device comprising:
a storage housing having a housing cover and a side flange, the side flange having an aperture;
a cleaning cloth having a stop plug at a proximal end and a retraction cord at a distal end;
a spool of the storage housing upon which the retraction cord is coiled;
a retraction mechanism for biasing the spool to retract the retraction cord so that the cleaning cloth is biased towards a retracted position wherein the cleaning cloth is retracted into the storage housing until the stop plug abuts the aperture in the side flange of the storage housing, but so that the cleaning cloth pay be pulled out to an extended position for use;
an enclosure tank that holds a cleaning fluid; and
a pump mechanism for pumping the cleaning fluid from the enclosure tank into the storage housing to moisten the cleaning cloth.

2. The eyewear cleaning device of claim 1, wherein the stop plug includes a pull tab that may be gripped to pull the cleaning cloth out of the storage housing.

3. The eyewear cleaning device of claim 1, wherein the retraction mechanism comprises:
a spindle that extends upwardly from the enclosure tank, wherein the spool rotates on the spindle;
a spring within the spool and surrounding the spindle;
a gasket formed around the spindle for retaining the spool in place; and
a pivot arm formed between the spindle and the gasket, wherein the pivot arm stops the spool from retracting while the cleaning cloth is being pulled out of the storage housing.

4. The eyewear cleaning device of claim 1, wherein the pump mechanism is in the form of a button that pumps the cleaning fluid from the fluid reservoir and through an opening in the enclosure tank to moisten the cleaning cloth within the storage housing.

5. The eyewear cleaning device of claim 1, further comprising a mounting mechanism for mounting the device to an object or an article of wear.
